(19) United States
(12) Patent Application Publication
(10) Pub. No.: US 2026/0327118 A1
(43) Pub. Date: Oct. 22, 2026

(54) Integrated Non-Thermal Plasma System for Carbon Capture from Flue Gas and Contaminated Water Purification via Tuned Radical-Driven Nanomaterial Adsorption and Degradation

(71) Applicants: Debbie A Maguire, Evansville, IN (US); Jamie Bass, Evansville, IN (US)

(72) Inventors: Debbie A Maguire, Evansville, IN (US); Jamie Bass, Evansville, IN (US)

(73) Assignees: Elemental Air Indiana LLC, Evansville, IN (US); DMAG USA LLC, Evansville, IN (US)

(21) Appl. No.: 19/638,102

(22) Filed: Apr. 2, 2026

Related U.S. Application Data
(60) Provisional application No. 63/783,238, filed on Apr. 4, 2025.

(51) Int. Cl. C02F 9/00; B01D 53/32; B01D 53/44; B01D 53/50; B01D 53/56; B01D 53/62; C01B 32/184; C01D 15/04; C02F 1/24; C02F 1/28; C02F 1/32; C02F 1/461; C02F 1/72; C02F 101/20; C02F 101/34; C02F 101/36; C02F 103/18; C25B 1/50

(52) U.S. Cl. CPC C02F 9/00; B01D 53/32; B01D 53/44; B01D 53/50; B01D 53/56; B01D 53/62; C01B 32/184; C01D 15/04; C25B 1/50; B01D 2257/302; B01D 2257/404; B01D 2257/502; B01D 2257/504; B01D 2257/702; B01D 2258/0283; B01D 2259/818; C02F 1/24; C02F 1/283; C02F 1/32; C02F 1/46109; C02F 2001/46133; C02F 2001/46161; C02F 1/725; C02F 2101/20; C02F 2101/34; C02F 2101/36; C02F 2103/18; C02F 2201/005; C02F 2305/10

(57) ABSTRACT

The present invention provides an integrated non-thermal plasma system for carbon capture from flue gas and purification of water contaminated with PFAS (PFOS and PFOA), heavy metals, benzene, and pathogens. A first conical plasma apparatus employs tuned kilohertz oscillations and capacitance-controlled corona discharge to dissociate flue-gas oxides while entraining nanostructured carbon materials and hydrogen radicals into the water. The water then enters a second identical apparatus for additional hydrogen generation, polarization, and 185 nm VUV irradiation, achieving at least 95% removal of PFOS, PFOA, and heavy metals. Dissolved air flotation, in-situ powdered activated carbon adsorption, and granular activated carbon polishing yield 99.99% pure water at neutral pH. Excess hydrogen is captured for energy use, and spent PFAS-laden GAC is valorized with lithium brine to produce lithium fluoride and graphene. The system operates under ambient conditions using less than 8 kW total power.

### FIELD OF THE INVENTION

The present invention relates to the integrated treatment of contaminated non-potable water sources exceeding safe limits for hazardous substances, including Perfluoroalkyl (Per-) and polyfluoroalkyl substances, heavy metals such as lead and mercury, and organic compounds like benzene and toluene. Contamination may arise from industrial discharges, agricultural pesticides, or municipal wastewater.

The invention uniquely bridges flue gas emissions control with water remediation by utilizing non-thermal plasma with tuned oscillations and capacitance effects to generate reactive radicals and nanomaterials from gas streams, which are then applied to bind and degrade water contaminants. Typically, the water has a pH of 3-5, elevated turbidity, and biological pathogens, with contaminant levels at or above: Perfluoroalkyl and polyfluoroalkyl substances at 50-200 parts per billion, lead at 10-50 parts per million, and benzene at 1-10 parts per million. Associated risks include carcinogenicity, neurological impairment, and ecosystem disruption.

### Background of the Invention

Perfluoroalkyl (Per-) and polyfluoroalkyl substances in Water Supply: Perfluoro octane sulfonate and perfluorooctanoic acid, part of the Perfluoroalkyl and polyfluoroalkyl substances group, are persistent “forever chemicals” in drinking water.

A recent international study led by the University of New South Wales (Nature Geoscience, April 2024, O'Carroll et al.) revealed that many global water sources exceed the safe drinking limits for PFAS. Consequently, a substantial portion of the water we consume—even after treatment—contains PFAS levels that surpass safety thresholds. Areas with a history of using firefighting foams, such as military bases and fire training facilities, tend to show higher concentrations of these chemicals.

The World Health Organization (WHO) is actively developing guidelines for PFAS in drinking water, recognizing the potential health risks associated with prolonged exposure. These risks include links to certain cancers and other serious health issues.

Lead in Water Supply: Lead can infiltrate drinking water through the corrosion of plumbing materials containing lead, especially in conditions where water has high acidity or low mineral content. Common sources of lead include pipes, faucets, and fixtures, particularly in older homes and urban areas. Lead exposure poses significant health risks, especially to children, including developmental delays, learning difficulties, and neurological damage. The Environmental Protection Agency (EPA) has set the maximum contaminant level goal for lead in drinking water at zero, as no level of lead is considered safe.

Benzene in Water Supply: Benzene, a colorless and flammable liquid used in the production of plastics, resins, synthetic fibers, rubber, dyes, detergents, and pesticides, can contaminate water supplies through industrial discharges, leaks from underground storage tanks, and spills. Benzene is highly soluble in water and poses severe health risks, including cancer, immune system suppression, and anemia, even at low exposure levels. The EPA has established a maximum contaminant level for benzene in drinking water at 0.005 mg/L.

Biological Pathogens in Water Supply: Waterborne biological pathogens, including bacteria, viruses, pathogens and parasites, can cause diseases such as cholera, typhoid, hepatitis, and gastrointestinal infections. Common pathogens in contaminated water include Escherichia coli (E. coli), Vibrio cholerae, Salmonella, hepatitis A virus, rotavirus, Giardia, and Entamoeba histolytica. These pathogens can enter water supplies through sewage, animal waste, and agricultural runoff. Effective water treatment and sanitation practices are crucial to eliminate these pathogens and safeguard public health. Treatment must address both chemical and microbial threats.

Existing methods often rely on thermal or equilibrium-based processes, which are energy-intensive and less selective, producing bulk materials like carbon black without tuned structural control. The present invention overcomes these by employing non-thermal plasma with kilohertz oscillations and capacitance-tuned discharge for radical generation and nanomaterial production from flue gas, enabling low-energy, versatile integrated purification without high-temperature requirements. This tuned approach ensures efficient bond breaking across diverse contaminants, yielding high-value nanostructures with large surface area rather than amorphous carbon.

Recent standalone flash Joule heating processes developed at Rice University (Scotland et al., Nature Water (2025); Deng et al., Nature Reviews Clean Technology (2025); and related Rice University patents/applications such as US 2024/0116094 A1) have demonstrated ex-situ destruction of PFAS by selective cleavage of carbon-fluorine bonds at 800-1,200° C., followed by distillation to recover lithium fluoride (LiF) while converting residual carbon into graphene. Those methods, however, address only post-treatment hazardous-waste disposal of conventionally sourced spent filters and do not integrate with upstream flue-gas processing or water remediation. In contrast, the present invention generates the precise PFAS-adsorbing nanostructured carbon in situ via non-thermal corona discharge from actual combustion flue gas, entrains it directly into the contaminated water stream within the dual-cone plasma apparatus, utilizes that same carbon throughout the multi-stage purification (including hydrogen polarization and 185 nm VUV photolysis), and only then applies the flash-heating valorization step to the system-specific spent GAC. In contrast to the Rice University work, the present invention generates the precise PFAS-adsorbing nanostructured carbon (including single- and multi-wall carbon nanotubes, C₆₀, C₇₀, fullerenes, and graphene) directly from combustion flue gas in a closed-loop integration, where engineered carbon and PFAS chemicals are combined as the precursor in a single system, also enabling simultaneous ultra-low-energy water purification (≤8 kW total), hydrogen co-production, and waste-to-value recovery under ambient conditions, providing synergistic technical and environmental advantages not contemplated or achieved by the cited Rice University processes.

### SUMMARY OF THE INVENTION

The present invention provides an integrated, multi-stage system and method for simultaneously treating combustion-derived flue gas while purifying a contaminated liquid medium (particularly water containing Perfluoroalkyl and polyfluoroalkyl substances (PFAS)), generating hydrogen gas and high-value nanomaterials, and recovering commercially valuable products from what would otherwise constitute hazardous waste. The system achieves at least 95% removal of PFOS and PFOA in an intermediate stage and up to 99.99% overall contaminant removal in the final purified water stream, all under ambient or near-ambient conditions, with minimal energy input and without requiring elevated pressures or harsh chemical additives.

In one aspect, the invention comprises a first apparatus having an inner cone disposed concentrically within an outer cone, thereby defining an annular reaction zone therebetween. An array of electrodes is affixed to the inner cone and electrically coupled to a negatively polarized high-voltage source supplying between 30 kV and 100 kV. The electrodes function as cathodes and are coated, preferably by an autocatalytic plating process, with a catalytic co-deposit comprising one or more materials selected from the group consisting of carbon, copper, aluminum, tungsten, nickel, cobalt, and boron. This coating enhances hydrogen production efficiency by up to two times relative to uncoated electrodes.

In a preferred embodiment, a secondary catalytic region may lie beneath the water anode (i.e., along the flow path or in a downstream zone of the annular reaction area). The secondary catalyst comprises a mesh substrate formed of aluminum, copper, magnesium, nickel, steel, or a metal alloy thereof, which is first coated via autocatalytic plating with the catalytic co-deposit previously described (comprising one or more of carbon, copper, aluminum, tungsten, nickel, cobalt, and boron). This initial coating is then top-coated with composites incorporating carbon and/or cobalt. The enhanced catalytic surface promotes additional hydrogen generation when biased with electricity within the reaction zone.

A liquid medium, such as PFAS-contaminated water, serves as the anode and flows downward along the inner surface of the outer cone walls, generally opposite the electrode array. This configuration establishes the reaction zone in which non-thermal corona discharge is generated upon energization of the electrodes. The discharge is characterized by kilohertz-range oscillations and capacitance buildup, which produce controlled pulsed energy release for precise molecular-bond dissociation. The non-thermal nature of the process, driven by capacitance-tuned oscillations rather than exothermic heating, focuses electrical energy directly on dissociation and achieves an energy efficiency of 25-30 kilowatt-hours per ton of carbon-dioxide equivalent. This tuning enables the system to effectively process a wide range of contaminants and distinguishes the invention from conventional untuned thermal methods that yield lower-value products.

Flue gas typically originates from the combustion of hydrocarbons, refuse-derived materials, plastics, or similar wastes and containing CO, CO₂, NOₓ, SOₓ, and other airborne contaminants. The hydrocarbon-based gas is introduced into and passes through the reaction zone. Hydrogen radicals are produced inside the apparatus via electron impact dissociation of water vapor or other hydrogen-containing compounds present in the gas stream or liquid medium. Concurrently, multiple oxides (such as CO, CO₂, NOₓ and SOₓ) are dissociated, leading to the formation of nanostructured materials. Exemplary products include elemental sulfur, graphitic carbon, graphene, and various nanomaterials such as carbon nanotubes, fullerenes, and endohedral fullerenes, and related allotropes through radical chain reactions that proceed selectively at substantially ambient temperatures. The applied voltage, process flow rate, make-up air, and gas concentrations may be tuned to optimize radical kinetics and capacitance effects, thereby enabling adaptable processing of diverse pollutant streams while favoring production of high-value nanomaterials over bulk or low-grade carbon forms.

The resulting solid nanomaterials are entrained within the flowing liquid medium and conveyed to the second apparatus, while gaseous components (primarily O₂, H₂, and N₂) are separated and exhausted to the atmosphere.

In operational testing of the invention, prototypes burning the hydrocarbon bituminous coal recorded greater than a 90% reduction of CO2, CO, NOx and SOx at a flow rate of 1,200 m3/h at 1 atmosphere of pressure (no backpressure). In this particular experiment, the flue gas contained 2.33% CO2 which was combined with make-up air, which comprised 25% of the combined gas input to the unit. Total power usage for all pumps, motors, and equipment was less than 8 kW, with the high voltage power supply using less than 500 w of that power for dissociation.

Using two Testo 350 units, the incoming flue gas was probed and analyzed before entering the unit, and the second unit was used to probe and analyze the gas at the exit of the unit. Testing showed Oxygen production rose from 16.72% to 20.87%. Carbon Monoxide (CO) decreased from 3028 ppm to 139 ppm. Carbon Dioxide (CO2) decreased from 2.33% to 0.13%. Nitric Oxide decreased from 36 ppm to 1 ppm. Nitrogen Oxides (NOx) decreased from 36 ppm to 1 ppm. Sulfur Dioxides (SOx) decreased from 183 ppm to 12 ppm. Hydrogen decreased from 1155 ppm to 41 ppm. Temperature dropped from 92.4° C. to 7.9° C. The elemental carbon recovered from the DAF tank was tested, and contained 83.7% single and multi-wall carbon nanotubes, 10.5% C70, 4.8% C60, and 1.0% Carbon/graphite orthorhombic; which proves the existence of nanomaterial entrained in and recoverable from the water of the invention. In testing, it has also been proven that different combustion sources produce different amounts and types of nanomaterial.

The second apparatus is substantially identical in configuration and operation to the first. It receives the nanomaterial-entrained liquid stream exiting the first apparatus. These corona plasma derived nanomaterials, including elemental and nanostructured carbon forms such as carbon nanotubes, graphene, graphitic carbon, fullerenes, endohedral fullerenes, and related allotropes, effectively adsorb Perfluoroalkyl and polyfluoroalkyl substances (PFAS), heavy metals, and organic contaminants present in the liquid.

Within the second apparatus, additional hydrogen is generated which reacts with the surrounding water, and the water molecules are polarized to render them more reactive and more susceptible to photochemical activation by ultraviolet (UV) light. This polarization is effected by the energized electrode array on the inner cone and is further enhanced by a secondary catalytic region disposed beneath the water anode (i.e., along the flow path or in a downstream zone of the annular reaction area). The secondary catalyst comprises a mesh substrate of aluminum, copper, magnesium, nickel, steel, or a metal alloy thereof, which is first coated via autocatalytic plating with the catalytic co-deposit described above and subsequently top-coated with composites incorporating carbon and/or cobalt. The enhanced catalytic surface promotes substantial hydrogen generation within the reaction zone. Excess hydrogen produced is captured for subsequent energy reuse.

The liquid stream containing the polarized and excited water molecules, together with adsorbed contaminants, exits the primary reaction zone of the second apparatus and passes through a vacuum ultraviolet (UV) irradiation zone operating at a wavelength of 185 nm. This vacuum UV exposure initiates photochemical degradation through radical-mediated interactions that are synergistically enhanced by the plasma-primed and hydrogen-polarized state of the water molecules, thereby significantly improving the efficiency of bond cleavage and contaminant breakdown. The integrated adsorption, catalytic hydrogen production, polarization, and vacuum UV photolysis steps achieve at least 95% removal of perfluorooctanesulfonic acid (PFOS), perfluorooctanoic acid (PFOA), and heavy metals.

In preferred embodiments, the second apparatus leverages the same non-thermal corona discharge principles as the first, while the additional secondary catalytic mesh and vacuum UV stage provide complementary mechanisms for advanced contaminant sequestration and destruction, all under ambient or near-ambient conditions without requiring extreme temperatures or pressures.

The treated liquid exiting the vacuum UV irradiation stage is directed into a dissolved air flotation (DAF) tank equipped with a nano-bubbler and a skimmer. In this stage, dissolved air is released to form nano-scale bubbles that attach to suspended particulates, facilitating density-based separation. Excess plasma-derived carbon materials are lighter than water and thus float to the surface of the tank, where they are collected and removed by the skimmer. Heavier materials, such as elemental sulfur or other denser precipitates formed during the process settle to the bottom of the tank for separate collection or disposal.

A portion of the clarified liquid is diverted to a holding tank for final polishing. In the holding tank, the water is bubbled through powdered activated carbon (PAC) produced in situ by the apparatus during flue-gas processing (wherein carbon oxides are dissociated and converted into high-surface-area graphitic and nanostructured carbon forms suitable for activation and use as adsorbent). The dispersed PAC adsorbs residual Perfluoroalkyl and polyfluoroalkyl substances (including PFOS and PFOA), heavy metals, and other harmful organic or inorganic contaminants remaining in the liquid. Following adsorption, the PAC—now bound to the targeted contaminants—is separated and removed via a downstream granular activated carbon (GAC) filter system. The GAC filter serves as a polishing stage, adsorbing any remaining trace contaminants that may have escaped upstream treatment, thereby achieving a final water purity of 99.99% free of contaminants. Upon saturation of the GAC media with adsorbed species, the filter is regenerated or replaced, and the captured contaminants are set aside for use in a secondary external process for PFAS destruction. The resulting purified water exhibits a neutral pH of 6.8 to 7.2 and is substantially free of the contaminants, rendering it suitable for discharge, reuse, or further applications as required.

In preferred embodiments, the integrated multi-stage system approach minimizes energy input, avoids harsh chemicals or extreme operating parameters, and enables valorization of waste-derived carbon into functional adsorbents, thereby enhancing overall process efficiency and sustainability.

The contaminated GAC filter described above would normally be disposed of, however, another novel use has been discovered. In a further aspect of the invention, the saturated GAC filter, normally classified as hazardous waste due to adsorbed PFAS (fluorine atoms covalently bound to carbon structures), heavy metals, and other contaminants, is instead valorized through a novel downstream recovery process. The PFAS-laden GAC media is combined with a salt brine containing lithium ions. The mixture is subjected to flash Joule heating or laser heating to a temperature range of 800° C. to 1200° C., at which the fluorine-carbon bonds are selectively decoupled. Liberated fluorine atoms react with lithium ions in the brine to form lithium fluoride (LiF) in situ. The intensity of applied electrical charges, pulse configurations, heating rates, and peak temperatures are adjusted according to the concentrations of PFAS, carbon content in the GAC, and lithium in the brine to optimize yield.

Following LiF formation, the brine is subjected to a second heating step that raises the brine temperature to between 1400° C. and 2400° C., vaporizing the LiF, which is then collected and purified by distillation to yield high-purity lithium fluoride suitable for industrial reuse. Concurrently, the residual carbon matrix of the GAC is converted into graphene or graphene-like structures that may be harvested for use in energy storage, composites, electronics, catalysis, and other commercial applications.

This novel integrated recovery process represents a significant advance in that it not only destroys the persistent and hazardous PFAS compounds, thereby eliminating the environmental liability associated with conventional hazardous-waste disposal, but simultaneously recovers two commercially valuable products: high-purity LiF and graphene. In this manner, the invention transforms what would otherwise constitute a disposal problem into a resource-recovery opportunity, closing the loop on the multi-stage contaminant-removal system while operating without the need for additional chemical reagents or extreme pressure conditions.

The overall process enhances sustainability by converting combustion flue gas and contaminated water into purified water, reusable hydrogen, and industrially valuable graphene and LiF under ambient or near-ambient conditions.

### BRIEF DESCRIPTION OF THE DRAWINGS

FIG. 1 represents a frontal view of an apparatus that includes all of the components necessary to create activated carbon, create hydrogen, and purify water. This figure also illustrates an external process to beneficially destroy PFAS contaminated GAC filters. Not illustrated is a standard industrial control cabinet, which controls process flow, motors, valves, timing, and safety features.

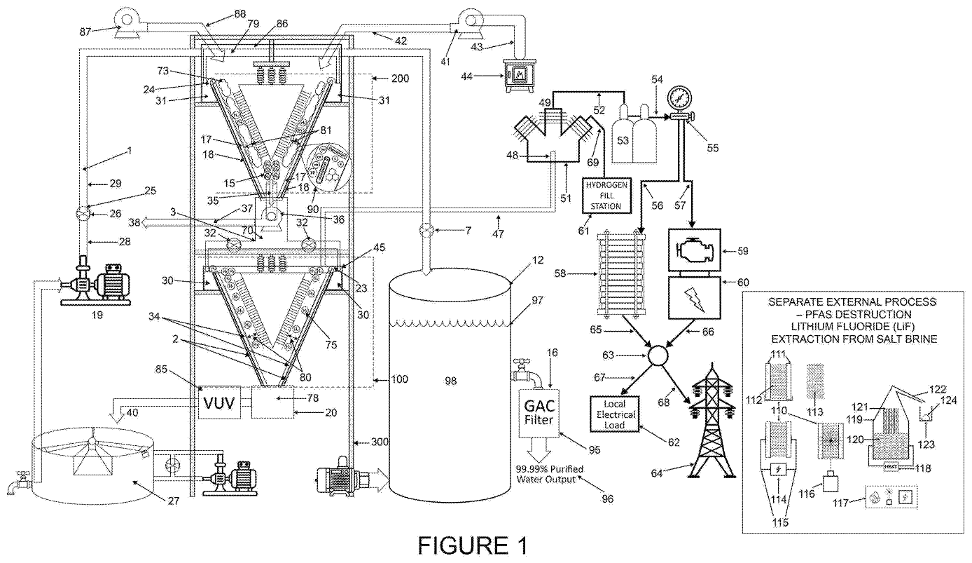

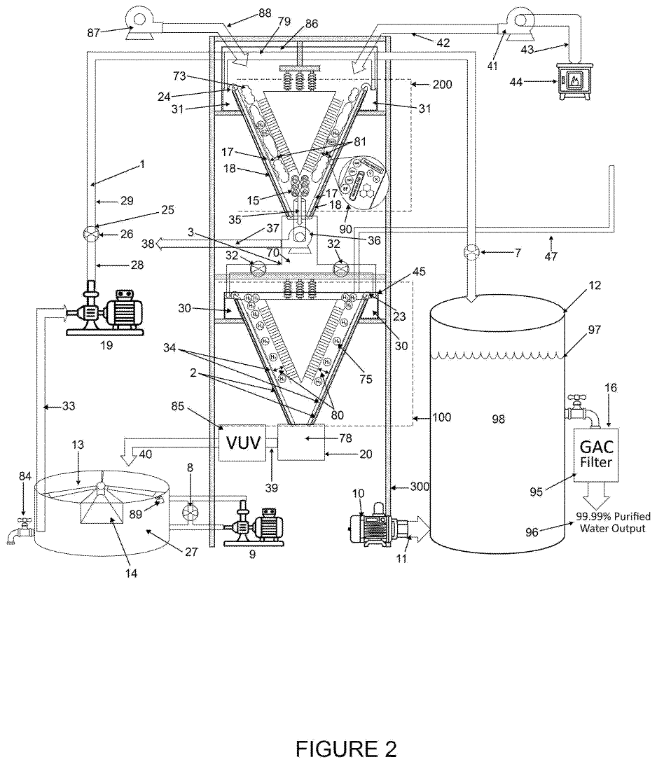

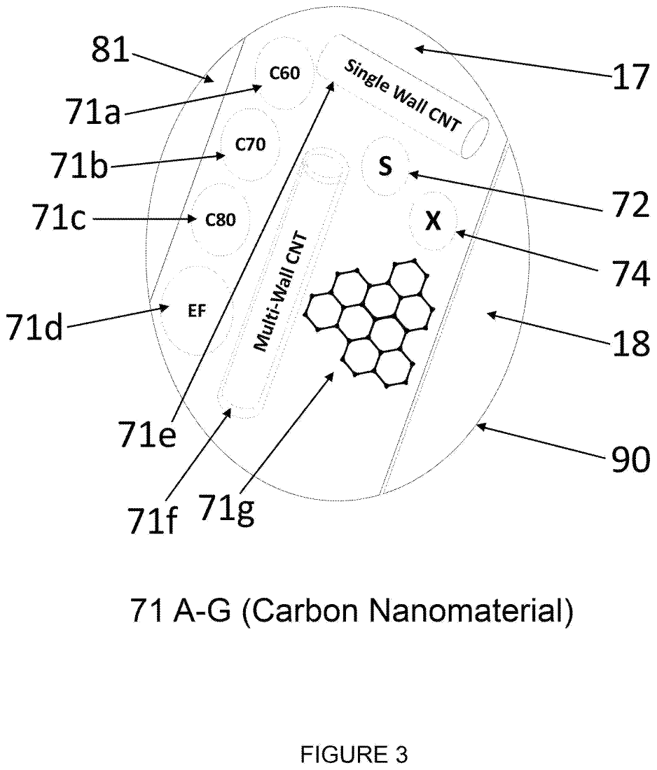

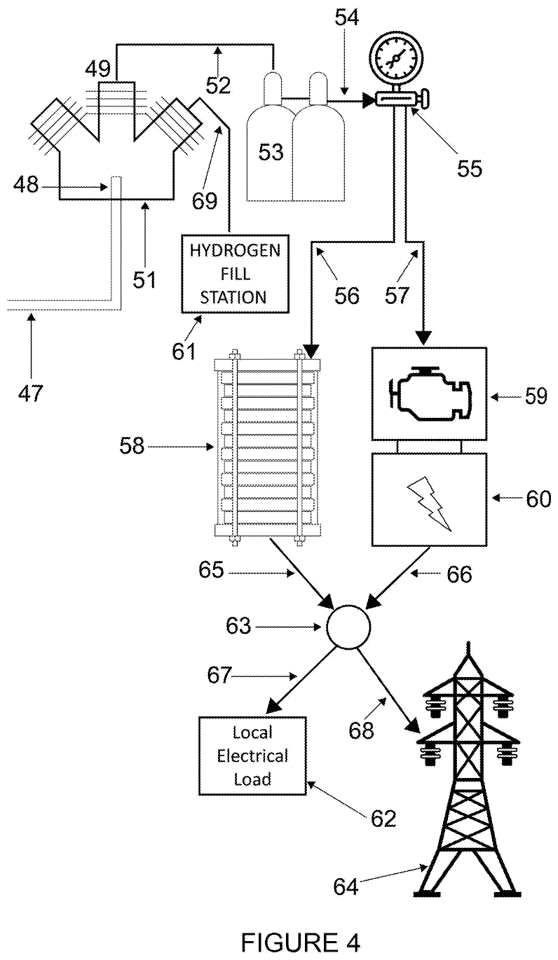

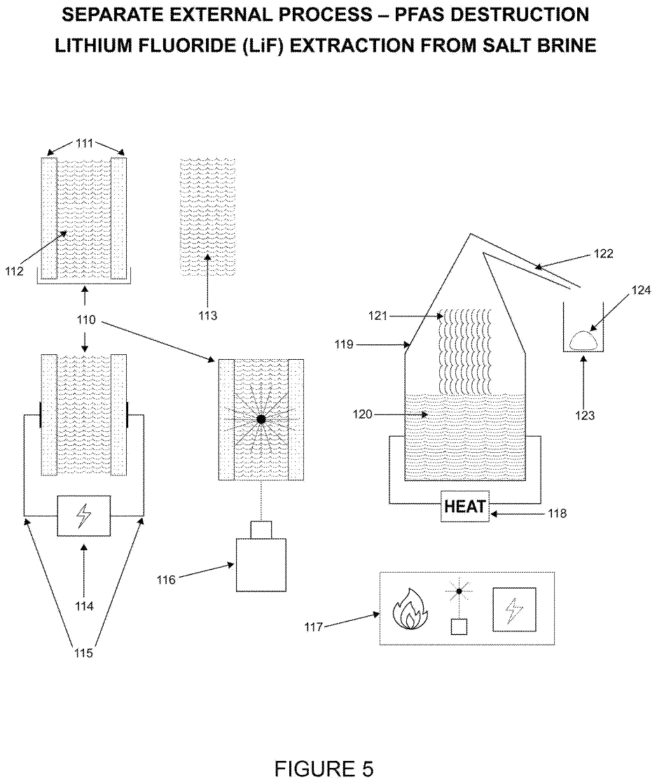

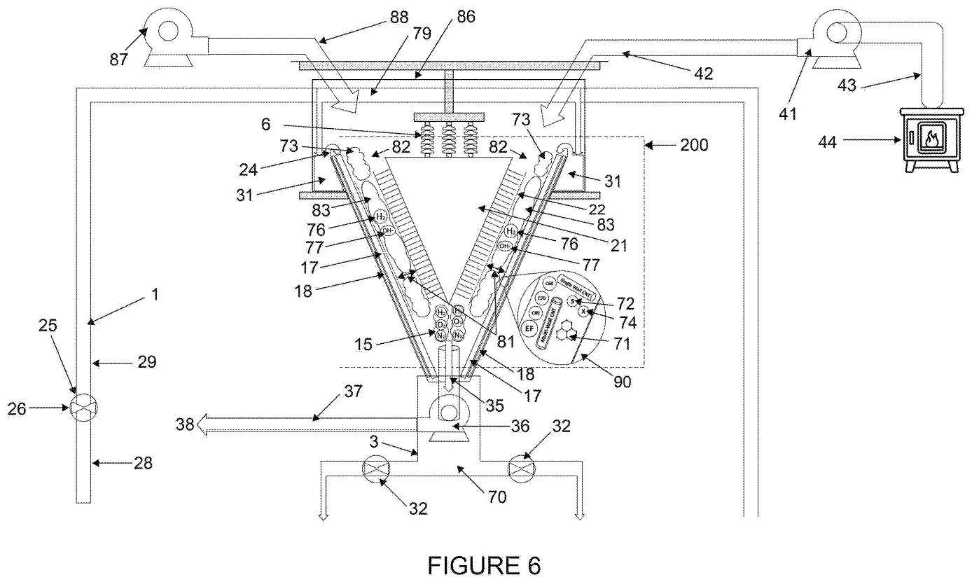

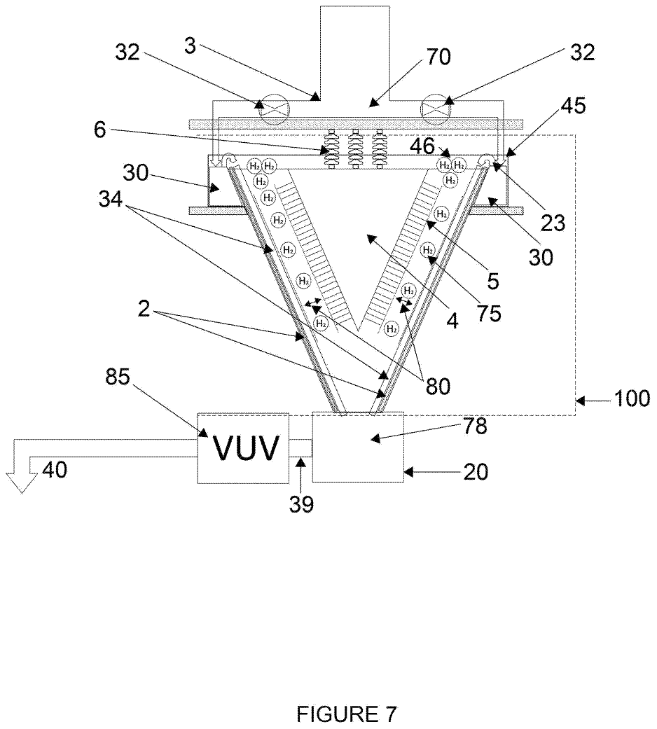

Components of FIG. 1 are broken down individually throughout the rest of FIGS. 2-7. Activities happening in the top apparatus (200) are further discussed in FIG. 6, while activities happening in the bottom apparatus (100) are further discussed in FIG. 7. FIG. 3 is an section-view illustration of item (90) in FIGS. 1 and 2, which show nanomaterials entrained in water (17). Excess hydrogen produced by the bottom apparatus (100) is carried by pipe (47) to a hydrogen compressor (51). FIG. 4 has a detailed description of how hydrogen is processed by the system and can be harnessed for many different uses. FIG. 5 outlines the external process used for PFAS destruction using PFAS saturated GAC filter contents (111) combined with lithium salt brine (112) and electricity (114, 115) to flash-joule heat the mixture, thereby creating a useful byproduct of Lithium Fluoride.

FIG. 2 is a segment of FIG. 1, illustrating the top apparatus (200) used to molecularly dissociate oxygen bonds to create nanomaterial (71a-g)(72)(74) in the water (17), and exhaust dissociated gasses (15) through a blower (36) to the exhaust (37) vented to the atmosphere (38). Hydrocarbons are combusted in an incineration device (44), which creates hydrocarbon exhaust flue gas (43). The top apparatus (200) is fed exhaust flue gas (43) through a length of duct work (42) (typically to cool the gas to the preferred processing temperature below 90° C.), through blower (41). Exhaust flue gas is illustrated in the top apparatus as item (73). Make-up air (88) (which is air pulled from the ambient surrounding atmospheric air around the apparatus) is fed to the top apparatus (200) through blower (87). The bottom apparatus (100) purifies and polarizes water through hydrogen bombardment (75) in the reaction zone (80), and creates excess hydrogen (75).

Pump (9) produces nano bubbles (controlled by valve (8)) for cavitation in the Dissolved Air Floatation (DAF) tank (27), which allows carbon to be floated to the top of the DAF tank (27). This carbon is then skimmed off the surface of the water by motorized skimmer arms (13), which are actuated by a small gear reduced motor (89). Skimmed carbon is deposited in chute (14), where it is collected for processing and other uses. Valve (84) is typically used for to drain the system for cleaning or maintenance. Pipe (33) is placed approximately mid-tank to allow the system to draw carbon entrained and polarized water (17, 34) back into the system by pump (19) to be fed to the top apparatus (200), and to water storage tank (12).

Pump (10) aerates (11) the holding tank (12) to bubble carbon entrained tank water (98) to bind to contaminants. Also illustrated is the vacuum ultraviolet water purification device (85). Nanomaterial entrained water (17) exits from the top apparatus (200), and feeds into the bottom apparatus (100) via manifold (3) with water flow controlled by valves (32). The bottom apparatus (100) then bombards the water (34) with hydrogen (75) and corona discharge plasma to polarize and ionize it. Polarized and ionized water (78), then flows through the Vacuum UV (VUV) device at 185 nanometer wavelength (85), which further breaks down PFAS chemicals and functions as an additional water purification device to kill any organics. Treated water exiting (40) from the VUV device (85) flows to the DAF tank (27). Elemental carbon is skimmed off the top of the DAF tank (27) by the skimmer (13), and is recovered from the chute (14). Water from the middle of DAF tank (27) is pumped by pump (19), then fed both to the top apparatus (200) and to the storage/adsorption tank (12), with the water level controlled by valve (7) and water level (97). Pump (10) aerates (11) the tank, and storage tank water (98) then passes through the final stage of water polishing, which is the GAC filter (95) to achieve 99.99% pure water.

FIG. 2 also illustrates the water tank (12), Granular Activated Carbon (GAC) filter (95), and various pumps, valves, and blowers. Pump (19) feeds water to the first apparatus (200) and the water holding tank (12), controlled by valve (7) to maintain the proper water level (97).

Additionally, the excess hydrogen generated by the bottom apparatus (100) is carried through pipe (47) to the hydrogen compressor (51)(FIG. 4).

FIG. 3 is a section view (90) of the water (17) from the inside of the top apparatus (200). The section view illustrates some of the materials that can be generated in the water; including but not limited to C60 (71a), C70 (71b), C80 (71c), Endohedral Fullerenes (EF) (71d), Single Wall Carbon Nanotubes (71e), Multi Wall Carbon Nanotubes (71f), Sulfur (S)(72), Graphene Sheets (71g), and other materials (X)(74). In other areas of this document, anytime (71) is referred to, it is referring to all or various carbon nanomaterials (71a-71g).

FIG. 4 illustrates an embodiment of how the hydrogen produced by the bottom apparatus (100) could be compressed and used for various purposes, including but not limited to a hydrogen fill station (61) or compressed storage (53). From compressed storage (53), the hydrogen can be regulated (55) down to a lower pressure for use in a hydrogen fuel cell (58) to produce DC voltage, or be routed to an internal combustion engine (59) and generator (60) to generate AC electricity (66). Electricity can be directly used, or in an ideal embodiment it could go to a micro-grid controller (63), which can route usable electricity wherever it is needed, whether to the grid (64), a local electrical load (62), to equipment, or any of a plurality of uses for electricity. This diagram illustrates only a few of the many uses of hydrogen and power generation/consumption.

FIG. 5 describes an external process where used PFAS infused carbon from the saturated GAC filter (111) is ethically destroyed. In one embodiment, salt brine with lithium (112) is walled on both sides with PFAS saturated carbon (111). In another embodiment, the salt brine with lithium is mixed with PFAS saturated carbon to form a slurry (113). The conversion phase consists of using electrodes (115) that are affixed to the mixture. An electric field (114) is applied to flash joule heat the mixture, creating graphene and Lithium Fluoride (LiF). Alternately, instead of applying electrodes (115) or an electric field (114), a laser (116) can be used to achieve the same effect.

The second phase of processing requires heating (118) of the graphene and LiF mixture (120) in a distilling vessel (119) using any of a variety of heating methods (117). When the mixture (120) is heated past the vaporization point of the Lithium Fluoride, the gaseous LiF (121) flows through the cooling area (122) and condenses into solid LiF (124) as it is collected in a separate container (123).

FIG. 6 is a larger view of the top apparatus. This diagram is a section view from FIG. 1, but has a higher level of detail. As similarly stated in FIGS. 1 and 2, hydrocarbons (like coal, oil, diesel, etc.) are combusted in an incinerator (44), which produces a hydrocarbon rich exhaust flue gas (43). The exhaust flue gas (43) is fed into blower (41), through a cooling pipe (42), (so that gas temperature does not exceed 90° C.) before entering into the gas diffuser (86). The gas diffuser (86) feeds into the top apparatus (200), providing the source of hydrocarbon gas (73) for the reaction zone (81). The make-up air blower (87) draws ambient air from the outside atmosphere, and also feeds that into the gas diffuser (86), providing additional oxygen to the reaction zone (81). The diffuser (86) mixes flue gas (73) and make-up air (88), while also preventing those components from escaping from the process entry point (82).

The system is initially filled with water by opening water inlet valve (25), which allows water to enter pipes (28) and (29) from an outside water (26) source. After the system is full, the valve (25) is closed to outside water (26). Water is supplied to the upper apparatus (200) water feed manifold (79) when inlet valve (25) is open between feed pipes (28) and (29) while being closed to outside water inlet (26). Pump (19) provides pressurized water (1) in feed pipe (29) to feed the top apparatus (200), which flows into the weir tanks (31) through manifold (79), then overflows (24) down the inside of the outer cone, over the cathodes (18). Once flue gas (73) and flowing water (17) are present in the reaction zone (81), high voltage is applied to metal electrodes (22) affixed to the injector (21), suspended by insulators (6) from the support frame (300). Due to the unique relationships between the geometry of the outer cone of the top apparatus (200), high voltage, the water flow, and the gas flow, capacitance builds up and amplifies the dissociative effect of hydrogen (76) and hydroxyl radicals (77) on oxygen bonds, thus accomplishing gas purification (83) via molecular dissociation in the reaction zone (81). Various carbon nanomaterials (71) are deposited in the flowing water (17) and are carried to the water collector (70) enroute to feed carbon entrained water to the bottom apparatus (100) through manifold (3) which is flow controlled through valves (32). Purified dissociated gases (15) are pulled out of the system (35) by blower (36), and exhausted to the atmosphere (38).

FIG. 7 is a larger view of the bottom apparatus (100). This diagram is section view from FIG. 1. The bottom apparatus (100) is primarily used to ionize particles and bombard them with hydrogen (75) to amplify the breakup of PFAS bonds and facilitate the bonding of carbon to harmful particulates in the water stream (34). There is no airflow into this system, only an outflow of hydrogen from opening (46) to pipe (47)(FIGS. 1 and 2) that feeds a hydrogen compressor (51) (FIG. 4). When carbon entrained water (70) in water feed manifold (3) is introduced to the bottom apparatus (100), it flows into the weirs (30), where it overflows (23) onto the cathodes (2) attached to the inside of the outer cone. The top cone and bottom cone injector (4), electrodes (5) and layout are identical in configuration except for the airflow. When water flow is sufficient, the high voltage is turned on to the injector (4), which starts producing a corona discharge from the autocatalytically plated metal electrodes (5). The corona discharge, in concert with a bias voltage on the cathodes (2) facilitates a very strong reaction, dissociating hydrogen from the flowing water. This also ionizes and polarizes molecules in the water, causing further dissociation of PFAS in the water, and also binding it to carbon already entrained in the water. Excess hydrogen is recovered, from opening (46), and polarized and ionized water (78) flows out of the bottom apparatus (100) into the collection box (20). The water collection box (20) feeds the vacuum ultra violet light (85), running at 185 nanometers, which is ideal for the further dissociation of PFAS and any organics that may still be in the water. Exit pipe (40) takes the 95% PFAS treated water to the Dissolved Air Floatation (DAF) tank (27), where carbon is separated by skimmers (13) and deposited in the removal chute (14).

### DETAILED DESCRIPTION OF THE INVENTION

### Method

The apparatus discussed herein relates to a system of systems, consisting of multiple processes that work together primarily to:
(1) Process waste effluent flue gas to create activated carbon,
(2) Create hydrogen to purify water,
(3) Utilize that activated carbon to bind to contaminants, and
(4) Filter bound contaminants to produce purified water.
(5) Dispose of PFAS chemicals producing useful byproducts.
   Filling with Contaminated Water:

The first step in operating the apparatus is filling the apparatus with water. Typically, with water that has contaminants such as PFAS, PFOS, PFOA and other harmful or non-desirable components. This water is introduced to the apparatus via input water pipe (26) while valve (25) is open. When the system is filled with an adequate amount of water to operate, valve 25 is closed, thereby shutting off input water pipe (26) and reestablishing water flow in the system by rejoining pipes (28) and (29).

### Water Flow Through the System:

The apparatus requires water to be flowing through the system to operate. Water (1) is pumped through the system using a typical off-the-shelf water pump (19), typically driven by an electric motor. The water pump is typically controlled using a variable frequency drive (VFD) (not pictured here) to control the speed and power of the electric motor, thereby controlling the water pressure and flow of the water (1) flowing through the system. Pipe (33) is connected to the intake of the water pump (19), which is also connected to the bottom of the Dissolved Air Flotation (DAF) tank (27), which should be full of water after the water filling process in the first step described above. Water Pump (19), through intake pipe (33), pulls water from the bottom of the DAF tank (27) and pushes it through the water pump (19) output pipe (28), through valve (25), through pipe (29), into the weir reservoir (31) of the top apparatus (200). As the weir reservoir (31) fills up, it starts to overflow (24) onto the inner cathode walls (18) of the cone or wedge of the top apparatus (200). The water flowing from the weir reservoir (17) flows down the inner cathode walls (18) at a constant flow rate and constant depth and collects in the top apparatus (200) collection box (3).

### Stage 1 Water Purification

Contaminated air (43) is typically generated in a combustion process (44) and contains hydrocarbons and other molecules such as carbon dioxide (CO2), carbon monoxide (CO), nitrogen oxides (NOx), sulfur oxides (SOx), water vapor (H2O), and residual oxygen (O2), along with particulate matter (PM) like soot and fly ash depending on the fuel source and combustion process. The contaminated air (43) is pulled from the combustion source (44) by a blower (41), which forces the exhaust flue gas (73) to travel a distance to cool and dissipate heat through a pipeline (42) so that the incoming temperature of the exhaust flue gas (73) is over 150° Fahrenheit and under 200° Fahrenheit as it enters the diffuser (86), which channels the through opening (82). Blower (41) is controlled by a variable frequency drive (VFD) (not pictured), which controls the speed of the contaminated air (43) going into the top apparatus (200).

### Tuning of Kilohertz-Range Oscillations and Capacitance-Controlled Discharge

The concentric cone-within-cone geometry of the apparatus deliberately creates an annular reaction zone that functions as a dynamic, distributed capacitor. The inner cone supports the array of high-voltage cathodes (coated with the autocatalytic catalytic co-deposit), while the outer cone's inner surface carries a thin, continuously flowing film of contaminated water (typically 1-10 mm thick) that serves as the anode. This water layer, combined with the gas mixture (flue gas+make-up air) and hydrogen/water vapor generated in situ, forms the dielectric medium between the electrodes. The variable annular gap (50-250 mm in the tested prototype reaction zone) and the curved geometry produce a unique capacitive effect that enables controlled energy storage and rapid pulsed release in the kilohertz frequency range (typically 20-100 kHz). High negative voltage of −30 KV to −100 KV is applied to the coated cathode array in the working prototype. The resulting electric field (calculated at 430 kV/m across the reaction zone gap) is modulated by the changing capacitance as water flows and gas composition varies, generating self-sustained kilohertz oscillations without requiring external capacitors or complex pulse generators in the basic embodiment. Hydrogen radicals and water vapor provide effective cooling of the discharge zone due to their high thermal conductivity, maintaining strongly non-thermal conditions (as evidenced by exit gas temperature in the prototype dropping to ~8° C.) where electron energy is preferentially transferred to molecular dissociation rather than gas heating. At the tested flue-gas flow rate of 1,200 m³/h, power consumption measured 325 W for the corona discharge stage. Prototype testing evidenced amperage scales directly with the mass flow rate and particle/contaminant loading of the incoming flue gas: higher gas throughput and greater numbers of dissociable molecules increase conductivity and power demand, allowing the system to self-adjust while remaining within the overall system power envelope (<8 kW total for pumps, motors, and HV supply). The reaction zone length further optimizes the distributed capacitance along the flow path. Tuning is accomplished empirically by the operator through iterative adjustment of the following parameters while monitoring key performance indicators: (1) cathode voltage (−30 KV to −100 KV), (2) water flow rate (which controls anode film thickness and uniformity), (3) flue gas and make-up air flow rates via variable frequency drives, (4) secondary catalyst mesh bias voltage when used, and (5) the physical cone dimensions and gap spacing (selected during apparatus fabrication). Optimal tuning is reached when the system achieves >90% reduction in CO₂, CO, NOₓ and SOₓ, maximum production of high-value nanostructured carbon (predominantly single- and multi-wall carbon nanotubes with minor fullerenes), and minimum energy consumption (25-30 kWh per ton of CO₂ equivalent processed), all while maintaining much lower exit gas temperatures (as evidenced below 10° C. in prototype testing). Gas composition is monitored in real time (e.g., with Testo 350 analyzers), and nanomaterial yield is verified by sampling the entrained solids from the downstream dissolved air flotation tank. This capacitance-tuned, kilohertz oscillatory discharge focuses electrical energy precisely on radical chain reactions and bond dissociation under ambient conditions, distinguishing the invention from conventional high-power thermal or untuned plasma systems.

Once contaminated air (43) is flowing into the opening (82) via the diffuser (86) of the top apparatus (200), and the water (17) is flowing evenly down the inner walls of the top apparatus (200) over the cathodes (18), then, blower (36) is switched on to facilitate the flow of gases through pipe (35) at the same rate that the make up air gas (88) and exhaust flue gas (73) are being fed into the opening (82) by the diffuser (86), fed by blower (87) and blower (41) respectfully. All blowers are controlled by a Variable Frequency Drive (not pictured) to assure the speed and gas flow can be precisely adjusted. Now that the water flow (17) and the gas flow (83) through the reaction zone (81) are both optimal, the operator of the process will switch on the high voltage electricity to the multi-point injector (21), which energizes the coated electrodes (22) with voltage in the range of −30 KV to −100 KV. Additionally, the cathodes (18) will be energized with a catalyst bias voltage, thereby increasing the molecular dissociation activity within the reaction zone (81).

According to the zoomed in section view labeled (90) in FIG. 3, a blown-up version of the water flowing (17) and cathode (18) can be observed, which illustrates nanomaterial (71) entrained in the flowing water (17). While the top apparatus (200) is in operation, molecular dissociation happens inside the reaction zone (81), which breaks oxygen bonds of CO2, CO, NOx, SOx. This process utilizes non-thermal corona discharge inside a tuned reaction zone (18) to create the ideal capacitance to facilitate kilohertz discharge oscillations inside the reaction zone (81) as voltage, capacitance, water flow, and gas flow are ‘tuned in’ to produce the optimal output (to optimize gas cleaning and produce high value nanomaterial). Tuning in this context not only relates to changing the process parameters, but also the shape, dimensions, and configuration of the ‘cone within a cone’ hardware, which optimizes the capacitive discharge effect at the optimal frequency.

Hydrogen (H2) (76) and Hydroxyl radicals (OH—) (77) interact with the make-up air combined flue gas (83) in this optimized reaction zone (81) environment, and facilitate low-energy molecular dissociation. As that process happens, atoms and molecules that are heavier than air (C60, C70, C80, Single and Double Wall Carbon Nanotubes, Endohedral Fullerenes (EF) (71a-g), Sulfur (72), and other solids and particulates ‘X’ (74) enter into the flowing water (17), while gases that were liberated that are lighter than air (H2, O2, N2) (15) will be free floating within the lower part of the apparatus, ready to be pulled out as clean air through pipe (35) by blower (36) through piping (37) to the outside atmosphere (38).

### The Purpose of the Top Apparatus (200)

As stated in the abstract, this invention is designed to purify water using multiple methods. The top apparatus (200) functions as an activated carbon generation machine that embeds activated carbon (71a-g) in the water stream (17). The source of this activated carbon is the byproduct of processing an effluent flue gas (83) to generate molecular carbon structures with high surface area and unique nanostructures—which are perfect for achieving maximum water purification effectiveness.

With activated carbon embedded in the flowing water (17), contaminants such as PFOS, PFAS, and other non-desirable compounds will start binding to the activated carbon produced by the top apparatus (200). The flowing water (17) then exits from the top apparatus (200) reaction zone (81), then flows into the water aggregation collector (3). From there, the water flows into the bottom apparatus (100) for the next stage of processing.

### Stage 2 Water Purification

As stated earlier, the bottom apparatus (100) is specially configured to use high concentrations of hydrogen to purify contaminants from water and ionically charge water particles. As water flows out of the top apparatus (200), the water entrained with nanomaterials (70) flows from the water aggregation collector (3) and is channeled through flow control valves (32), and enters into the weir reservoirs (30) of the bottom apparatus (100). As water continues to fill the weir reservoir (30) of the bottom apparatus (100), the water overflows (23) over the top edge of the inner wall of the outer cone. The inner wall of the bottom apparatus (100) is lined with cathodes (2) (just like the top apparatus (200)) to help further excite the particles in the bottom apparatus (100) reaction zone (80).

Once the water flowing (34) down the inner cathode walls (2) is consistent and even, the operator will switch on the high voltage electricity (between −30 KV and −100 KV) to the multi-point injector (4). The multi-point injector has specially coated needles (5) that facilitate excessive hydrogen release from the flowing water (34). Simultaneously, the inner cathode walls (2) may also be energized with voltage (−100 KV to 100 KV) to facilitate optimal hydrogen generation. Hydrogen molecules (75) are created within the reaction zone (80), and float up to the top of the bottom apparatus (100) because hydrogen is lighter than air. Ionized water flows out of the bottom apparatus (100) into the collection box (20) as an input for the Ultraviolet reaction chamber.

### Energizing the System to Achieve Hydrogen Generation:

### Hydrogen Use:

As hydrogen builds up in the top of the bottom apparatus (100), the apparatus lid (45) prevents the escape of hydrogen to the atmosphere. There is a hydrogen conveyance pipe (47) that is inserted into a hole (46) in the bottom apparatus lid (45), which carries hydrogen created in the bottom apparatus (100) to the hydrogen compressor (51) input port (48). The hydrogen compressor (51), then compresses the hydrogen generated (75) by the bottom apparatus (100), and outputs (49) compressed hydrogen to hydrogen storage tanks (53), or alternatively outputs (69) it to a local hydrogen fill station where external portable canisters of hydrogen are typically filled. Although these outputs are two common embodiments for the usage of hydrogen, they are merely examples and should not constrain other embodiments for the use of excess hydrogen. As an example of two practical embodiments of the usage of hydrogen, the output (54) of hydrogen storage tanks (53) could be fed into a hydrogen regulator (55), which would drop the pressure in the line from several hundred bar to lower pressures depending on the end use application. Lower pressures are common for use to feed (56) a hydrogen fuel cell (58) or feed (57) an internal combustion engine (ICE) (59). The desired output of a hydrogen fuel cell (58) is direct current (DC) electricity. Additionally, the internal combustion engine (59) in this embodiment is mechanically coupled to an electrical generator (60) and is most often used to make alternating current (AC) electricity. Excess electricity from the fuel cell (65) and electricity from the generator (66) could be fed into a micro-grid controller (63), which could route the needed electricity (67) to a local electrical load (62), and/or it could route electricity (68) to the local electrical grid (64). As stated earlier, these examples are only common embodiments for the use of excess hydrogen to generate electricity and describe that electricity's common use.

### Ultraviolet Sanitization (85) of Biological Agents (Stage 3)

The water aggregation collector (20) funnels water to pipe (39), which is the input to a vacuum UV light with an operating frequency of 185 nm (85), which is used to denature any biological agents and sanitize water. At this point, the water flowing through the UV sanitization system (85) results in water that is 95% free of PFOS, PFOA, and heavy metals.

### Carbon Harvesting

Carbon and particulate infused ionized water (78) that exits (40) the ultraviolet sanitization system (85) enters the Dissolved Air Flotation (DAF) tank (27). A DAF tank is a flotation tank used in the dissolved air flotation (DAF) water treatment process. In this process, air is dissolved into water under pressure and then released into the tank, causing tiny bubbles to form. This invention utilizes a cavitation process to dissolve air into the water with a water pump (9) and valve between the intake and output to allow air to be ‘sucked into’ the intake from the output, thereby shearing water and creating nanobubbles. These bubbles attach to suspended solids and other contaminants, causing them to float to the surface of the water. The motorized skimming device (13) removes the contaminants and the carbon floating on the surface of the DAF tank (27) by rotating around the tank and skimming the surface to mechanically force carbon and floating contaminants into the output chute (14). The majority of carbon in the output chute (14) will not have harmful contaminants because they will sink to the bottom of the DAF tank (27). Those contaminants are cleaned out periodically when the entire system is shut down for cleaning and sorted to be sold or responsibly destroyed. The plasma-generated radicals in the reaction zone (81) also oxidize trace heavy metals and other elements commonly present in combustion flue gas (73) (such as mercury, arsenic, lead, cadmium, selenium, and chlorine) into water-soluble ionic or acid forms. These oxidized species immediately dissolve into the thin water anode film (17) flowing along the outer cone. Upon exiting the reaction zone (81) and entering the dissolved air flotation (DAF) tank (27), the lighter nanostructured carbon nanomaterials (71a-g) (primarily single- and multi-wall carbon nanotubes and fullerenes) float to the surface and are collected by the motorized skimmer (13). In contrast, the heavier dissolved metal ions (74) and acid compounds remain in the aqueous phase or settle as sludge at the bottom of the DAF tank (27). This physical separation ensures that the recovered carbon product contains minimal residual heavy metals. As a result, the carbon nanomaterials collected from the skimmer chute (14) are expected to pass Toxicity Characteristic Leaching Procedure (TCLP) testing under EPA Method 1311 and are not classified as hazardous waste under RCRA regulations.

### Purification in the Holding Tank (Stage 4)

The entire system will run continuously utilizing the same hydrogen ionized water (78) and activated carbon infused water (70) until the operator decides to open valve (7) to deposit purified water into the holding tank. Before this valve (7) is opened, several components must be turned off. Specifically the effluent gas stream (43) is turned off, the high voltage electricity is turned off, the ultraviolet sanitization system (85) is turned off, and the hydrogen compressor (51) is turned off. Carbon infused and hydrogen ionized water (1) is drawn by water pump (19) from the DAF tank (27) through pipe (33). Water Pump (19) then pushes water (1) through valve (25) through pipe (29), through an open valve (7), causing holding tank (12) to fill with water. When the holding tank (12) has sufficient water, the operator may shut off water pump (19) and let the water running throughout the rest of the system all drain down to the DAF tank (27). At that point, the DAF tank (27) can be fully drained using valve (84) and the operator can clean the heavy metals, PFOS, PFAS, and other contaminants from bottom of the DAF tank (27) for sale or proper disposal.

In the holding tank (12), ionized water (78) and carbon infused water (70) is present. An air pump (10) is turned on to send compressed air (11) into the holding tank (12). The active carbon (71a-g) in the water is further encouraged to bind with any remaining contaminants that may be in the holding tank (12) water. After a period of time, the water inside the holding tank (12) is considered processed, and is now ready for the final purification step.

### Granular Activated Carbon (Gac) Processing (Stage 5)

The final stage of water purification happens when the holding tank water is filtered through an operator constructed Granular Activated Carbon (GAC) filter (95), which brings the water purification level to 99.99% (96). The Granular Activated Carbon (GAC) filter is made by further activating carbon that was removed from the DAF tank (27) output chute (14), using Potassium Hydroxide (KOH) to activate and expose more of the carbon's surface area. After the carbon is activated, it is added to a reusable filter housing with filter media that allows water to flow but prevents the carbon from flowing through. Holding tank (12) exit water valve (16) is turned on, allowing water from the holding tank (12) to flow through the Granular Activated Carbon (GAC) filter housing (95) containing the activated carbon. The activated carbon takes the water purity level to 99.99% and assures the PH of the water is neutral at a pH of 6.8 to 7.2. The Granular Activated Carbon (GAC) filter (95) is one of the best ways to assure the 99.99% removal of PFOS, PFOA, and heavy metals.

The purified water output (96) from this invention can be consumed by any human or animal, or used as an input to any chemical process with no ill or harmful effects.

### External Pfas Disposal and Beneficial Product Process

FIG. 5 illustrates a two stage process where PFAS is destroyed, and Lithium Fluoride and Graphene are beneficially created. The first stage of this process involves the combining of PFAS saturated carbon (111) that is recovered from a GAC filter housing (95), and a salt brine containing lithium (112). In the first embodiment, the PFAS saturated carbon (111) is illustrated on the sides of the container with the salt brine (112) filling the space in the middle (110). In another embodiment, the PFAS saturated carbon (111) and lithium salt brine (112) are combined together to produce a slurry (113).

The next part of the first stage is to flash heat the mixture (110)(113) between 800° C. and 1,200° C., which frees the carbon-fluorine bonds. This allows the lithium ions in the salt brine to bind with the fluorine in the mixture, creating Lithium Fluoride (LiF). Simultaneously, graphene is produced from the flash heating. The heating method can be many methods, including flash-joule heating by electricity (114) using electrodes (115), and by laser (116). Flash joule heating using electricity at 300 volts at 260 amps was used for initial testing. Stage 1 concludes with the destruction of PFAS and the creation of graphene and LiF (124).

The next stage of the process involves the recovery of Lithium Fluoride (124) out of the stage 2 slurry mixture (120). The mixture is placed in a distillation vessel (119), and then heat (118) is applied from any of a variety of sources (117), including but not limited to flame, laser, or electricity. As the mixture (120) is heated to a temperature 1,400° C. to 2,400° C., the Lithium Fluoride vaporizes (121), and collects in the cooling tube (122), where it condensates and is collected in another container (123) as high-purity solid Lithium Fluoride (124). The graphene and other components within the mixture (120) may be further refined to recover other components present from the PFAS saturated carbon (111) or the lithium salt brine (112), however, that is a separate and non-related process from the PFAS destruction and LiF (124) recovery methods of this process.

### Working Examples

The following working examples illustrate the operation of the integrated non-thermal plasma system and demonstrate that a person of ordinary skill in the art can make and use the invention without undue experimentation. All percentages and values reported are by weight unless otherwise indicated

### Example 1—Flue-Gas Reduction and Nanomaterial Production (Bituminous Coal Combustion Source)

A prototype system was operated with bituminous coal combustion flue gas at a flow rate of 1,200 m³/h at 1 atmosphere. The first apparatus (top cone) was energized at between −30 kV and −100 kV. The autocatalytic co-deposit was functioning on the cathodes (5 μm thickness). Results were measured with two Testo 350 analyzers and confirmed by downstream DAF-skimmed carbon analysis:

TABLE 1
Flue-Gas Reduction Results

| | | | |
|---|---|---|---|
| Parameter | Inlet | Outlet | % Reduction |

| CO₂ | 2.33% | | 0.13% | | 94.4% |
|---|---|---|---|---|---|
| CO | 3028 | ppm | 139 | ppm | 95.4% |
| NOₓ | 36 | ppm | 1 | ppm | 97.2% |
| SOₓ | 183 | ppm | 12 | ppm | 93.4% |
| Exit temperature | 92.4 | °C | 7.9 | °C | — |

Energy efficiency: 25-30 kWh per ton of CO₂ equivalent; high-voltage supply consumed only 325 W; total system power (pumps, motors, HV supply) remained under 8 kW.

TABLE 2
Nanomaterial Composition (Elemental
Carbon Recovered from DAF Tank)

| Component | Weight % |
|---|---|
| Single- and multi-wall CNTs | 83.7% |
| C₇₀ fullerenes | 10.5% |
| C₆₀ fullerenes | 4.8% |
| Graphitic carbon | 1.0% |

The entrained carbon comprised at least 80% single- and multi-wall carbon nanotubes together with C₆₀ and C₇₀ fullerenes.

### Example 2—Full-System Water Purification Performance

The identical prototype was operated with the same parameters on water contaminated with PFAS (150 ppb combined PFOS/PFOA), lead (25 ppm), benzene (5 ppm), and E. coli (10⁵ CFU/mL), inlet pH 3-5. After the second apparatus+185 nm VUV stage and final KOH-activated GAC polishing, the following results were obtained:

TABLE 3
Contaminant Removal Results

| Contaminant | Inlet Concentration | | Final Outlet | | % Removal |
|---|---|---|---|---|---|
| PFOS + PFOA | 150 | ppb | <1.5 | ppb | ≥99% |
| (combined) | | | | | |
| Lead | 25 | ppm | <0.25 | ppm | ≥99% |
| Benzene | 5 | ppm | <0.05 | ppm | ≥99% |

| | | | | |
|---|---|---|---|---|
| E. coli | 10⁵ | CFU/mL | None detected | 100% |

| | | | |
|---|---|---|---|
| Final pH | 3-5 | 7.0 | — |

Overall purity reached at least 99.99% with neutral pH of 6.8 to 7.2.

### Example 3—External PFAS Valorization of System-Specific Spent GAC

Spent GAC from Example 2 (KOH-activated, PFAS-saturated) was combined with lithium-ion salt brine and subjected to flash Joule heating (300 V, 260 A) to 800-1,200° C. followed by distillation at 1,400-2,400° C.

Results: >96% defluorination, high-purity LiF recovered (>99% purity by distillation), and graphene harvested from the residual carbon matrix.

As used throughout this specification, the terms “approximately,” “at least,” “substantially identical,” and “tuned” shall be understood to mean the specific parameters and performance values demonstrated in Working Examples 1-3 above, or any values falling within the explicit numerical ranges expressly recited in the claims.

1. A method for integrated non-thermal plasma treatment of flue gas and purification of contaminated water containing Perfluoroalkyl and polyfluoroalkyl substances (PFAS), heavy metals, benzene, and/or biological pathogens, the method comprising:
a. flowing contaminated water downward along an inner surface of an outer cone of a first apparatus, establishing a uniform 1-10 mm thick thin-film water anode layer via a weir reservoir overflow, while introducing combustion-derived flue gas containing CO, CO₂, NOₓ, SOₓ, and/or hydrocarbons into an annular reaction zone defined as 50-250 mm between the outer cone and a concentric inner cone bearing an array of high-voltage cathodes coated with an autocatalytic catalytic co-deposit;
b. energizing the coated cathodes with negative high voltage between −30 kV and −100 kV to generate self-sustained oscillations in the range of 20-100 kHz produced solely by the dynamic capacitance of the annular reaction zone without external capacitors or pulse generators, thereby producing capacitance-controlled non-thermal corona discharge that dissociates oxides in the flue gas via radical chain reactions to produce and entrain nanostructured carbon materials—including graphene, carbon nanotubes, fullerenes, endohedralfullerenes, C₆₀, C₇₀, C₈₀, C₁₂₀, and graphitic carbon, directly into the flowing water, wherein the entrained carbon comprises single- and multi-wall carbon nanotubes together with C₆₀ and C₇₀ fullerenes, while simultaneously liberating hydrogen radicals and lighter gases that are exhausted;
c. directing the nanomaterial-entrained water stream into a second apparatus substantially identical in geometry to the first apparatus;
d. flowing the nanomaterial-entrained water downward along an inner surface of the outer cone of the second apparatus while energizing a second array of coated cathodes and an optional secondary catalytic mesh (aluminum, copper, magnesium, nickel, steel or alloy substrate autocatalytically plated with the same co-deposit and top-coated with carbon/cobalt composites) with high voltage to generate excess hydrogen, ionize and polarize water molecules, and further enhance radical formation;
e. subjecting the polarized, nanomaterial-laden water exiting the second apparatus to 185 nm vacuum ultraviolet (VUV) irradiation to photochemically degrade adsorbed contaminants, achieving at least 95% removal of PFOS, PFOA, and heavy metals;
f. directing the VUV-treated water into a dissolved air flotation (DAF) tank equipped with a cavitation nano-bubbler formed by a pump and valve loop that shears water from the output back into the intake, wherein nanobubbles float lighter plasma-derived carbon materials and bound contaminants to a surface for skimming while denser precipitates settle;
g. transferring a clarified portion of the water to a holding tank, introducing compressed air to promote further adsorption by in-situ powdered activated carbon (PAC) produced during flue-gas processing, and passing the water through a granular activated carbon (GAC) polishing filter to achieve at least 99.99% contaminant removal and a neutral pH of 6.8 to 7.2, thereby producing potable water.

2. The method of claim 1, wherein the autocatalytic catalytic co-deposit on the cathodes of both apparatuses comprises at least two materials selected from the group consisting of carbon, copper, aluminum, tungsten, nickel, cobalt, and boron, and wherein the coating increases hydrogen production efficiency by at least two times relative to uncoated electrodes.

3. The method of claim 1, further comprising collecting excess hydrogen generated in the second apparatus and compressing the hydrogen for storage, fueling a hydrogen fill station, feeding a hydrogen fuel cell, or powering an internal combustion engine coupled to an electrical generator.

4. The method of claim 1, wherein the contaminated water entering the system contains PFAS at 50-200 ppb, lead at 10-50 ppm, benzene at 1-10 ppm, and/or biological pathogens selected from Escherichia coli, Vibrio cholerae, Salmonella, hepatitis A virus, Giardia, or Entamoeba histolytica.

5. The method of claim 1, wherein the first and second apparatuses operate under ambient or near-ambient conditions without external heating or elevated pressure, and wherein the tuned capacitance and 20-100 kHz oscillations focus electrical energy directly on molecular dissociation rather than thermal effects.

6. The method of claim 1, wherein the high-voltage power supply for the corona discharge utilizes less than 500 watts while processing flue gas at a flow rate of 1,200 m³/h at 1 atmosphere, achieving an energy efficiency of 25-30 kilowatt-hours per ton of carbon-dioxide equivalent, with total system power consumption (pumps, motors, and high-voltage supply) less than 8 kW.

7. The method of claim 1, wherein the contaminated water flows downward along the inner surface of the outer cone as the anode via a weir reservoir overflow, establishing a uniform thin-film water layer opposite the array of high-voltage cathodes on the inner cone.

8. The method of claim 1, wherein the cathodes are coated via an autocatalytic plating process with a co-deposit of at least two materials selected from carbon, copper, aluminum, tungsten, nickel, cobalt, and boron, and wherein a secondary catalytic mesh (aluminum, copper, magnesium, nickel, steel or alloy substrate) disposed beneath the water anode is further top-coated with carbon/cobalt composites, thereby increasing hydrogen production efficiency by at least two times relative to uncoated electrodes.

9. The method of claim 1, wherein the dissolved air flotation tank utilizes nanobubbles generated by a cavitation loop comprising a pump and valve that shears water from the output back into the intake, thereby creating nano-scale bubbles without external compressed-air injection.

10. The method of claim 1, further comprising bubbling the clarified water in the holding tank with in-situ powdered activated carbon (PAC) generated directly from dissociation of carbon oxides in the first apparatus, prior to polishing through the granular activated carbon (GAC) filter.

11. The method of claim 1, wherein the nanostructured carbon materials entrained in the water comprise single- and multi-wall carbon nanotubes, together with C₆₀, C₇₀, C₈₀, endohedral fullerenes, and graphene sheets, the exact composition being tunable by selection of the combustion source.

12. The method of claim 1, further comprising:
a. collecting PFAS-saturated GAC media from the polishing filter, wherein the GAC is produced in situ by dissociation of carbon oxides during the flue-gas processing step of the method and activated with KOH;
b. combining the saturated GAC with a lithium-ion-containing salt brine;
c. subjecting the mixture to flash Joule heating or laser heating to a temperature between 800° C. and 1,200° C., thereby selectively decoupling carbon-fluorine bonds, forming lithium fluoride (LiF) in situ, and converting the residual carbon matrix into graphene or graphene-like structures; and
d. heating the resulting mixture to between 1,400° C. and 2,400° C. in a distillation vessel to vaporize and recover high-purity LiF while harvesting the graphene, thereby valorizing what would otherwise constitute hazardous waste into commercially valuable products.

13. A system for integrated non-thermal plasma carbon capture from flue gas and purification of contaminated water, the system comprising:
a. a first plasma apparatus having an inner cone disposed concentrically within an outer cone defining an annular reaction zone with a gap of 50-250 mm, an array of cathodes affixed to the inner cone and coated with an autocatalytic catalytic co-deposit comprising at least two materials selected from carbon, copper, aluminum, tungsten, nickel, cobalt, and boron, a high-voltage source configured to deliver −30 kV to −100 kV to generate self-sustained oscillations in the range of 20-100 kHz produced solely by dynamic capacitance of the annular reaction zone without external capacitors or pulse generators, a flue-gas inlet, a make-up air inlet, and a water weir that flows contaminated water down the inner surface of the outer cone as a 1-10 mm thick thin-film anode, whereby non-thermal corona discharge produces and entrains nanostructured carbon nanomaterials (single- and multi-wall carbon nanotubes, C₆₀, C₇₀, and C₈₀ fullerenes, and endohedral fullerenes) into the water stream;
b. a second plasma apparatus substantially identical in geometry to the first apparatus and configured to receive the nanomaterial-entrained water, the second apparatus further comprising a secondary catalytic mesh (metal substrate autocatalytically plated with the co-deposit and top-coated with carbon/cobalt composites) positioned along the water flow path to enhance hydrogen generation and water polarization;
c. a 185 nm vacuum ultraviolet (VUV) irradiation stage downstream of the second apparatus;
d. a dissolved airflotation (DAF) tankwith cavitation nano-bubbler formed by a pump and valve loop that shears water from the output back into the intake and motorized skimmer downstream of the VUV stage;
e. a holding tank with air-bubbling capability and in-situ PAC derived from the plasma process; and
f. a granular activated carbon (GAC) polishing filter downstream of the holding tank, the entire system operating under ambient conditions to produce water of at least 99.99% purity at pH 6.8 to 7.2 while capturing excess hydrogen and enabling downstream recovery of LiF and graphene from spent GAC.

14. The system of claim 13, further comprising a hydrogen compressor, storage tanks, and at least one of a hydrogen fuel cell or internal combustion engine coupled to an electrical generator for utilization of captured hydrogen.

15. The system of claim 13, further comprising an external PFAS valorization module configured to receive PFAS-laden GAC, combine it with lithium-ion salt brine, apply flash Joule or laser heating (800-1,200° C.) followed by distillation heating (1,400-2,400° C.), and recover high-purity LiF and graphene.

16. The system of claim 13, wherein the nanostructured carbon nanomaterials entrained in the water include at least one of graphene sheets, single-wall carbon nanotubes, multi-wall carbon nanotubes, C₆₀, C₇₀, C₈₀, C₁₂₀, fullerenes, or endohedral fullerenes.
